(19) United States
(12) Patent Application Publication
(10) Pub. No.: US 2021/0023400 A1
(43) Pub. Date: Jan. 28, 2021

(54) SEAT FOR SAFETY HARNESS

(71) Applicant: Ramil Ravilyevich Musakaev, Samara (RU)

(72) Inventor: Ramil Ravilyevich Musakaev, Samara (RU)

(21) Appl. No.: 16/917,942

(22) Filed: Jul. 1, 2020

Related U.S. Application Data
(60) Provisional application No. 62/876,784, filed on Jul. 22, 2019.

(51) Int. Cl. A62B 35/00; A47C 1/00

(52) U.S. Cl. CPC A62B 35/0012; A47C 1/00

(57) ABSTRACT

A seat for safety harness comprises a load-bearing framework formed by a one-way bending chain including multiple sequentially connected links, which form a support surface of the seat. A method of use of the seat for safety harness comprises, before the use, turning over the load-bearing framework so as to transit the load-bearing framework into its operational position. A method of manufacturing a seat for safety harness, the method comprising formation of a load-bearing framework by a one-way bending chain that includes multiple sequentially connected links forming a support surface of the seat. The use of the one-way bending chain for forming a load-bearing framework provides physiology-friendly abutment on ischial tuberosity so a risk of orthostatic collapse occurrence in the user is dramatically reduced. The seat does not impede walking when in the non-operational position, and its small weight and dimensions allow its use in sports and expeditions.

### CROSS-REFERENCE TO RELATED APPLICATIONS

This invention is a continuation of U.S. Provisional Patent Application No. 62/876,784 filed on Jul. 22, 2019, whole content of which is incorporated herein by reference.

### FIELD OF THE INVENTION

The invention relates to components of personal fall arrest systems, namely, to suspended seats for safety harnesses.

### BACKGROUND OF THE INVENTION

High-rise actions require use of safety harnesses for avoiding falls. Existing full body harnesses and sit harnesses exert pressure on pelvic organs and lower limb arteries when a body is in a suspended position, and thus they trigger a diseased condition known as orthostatic collapse. In order to avoid this problem and provide physiology-friendly abutment on ischial tuberosity during continuous operations in a suspended position, suspended work seats having rigid integral load-bearing frameworks and being attachable to safety harnesses are used in high-rise works, for example:1. TechnaCurv® Full Body Harnesses, Padded Saddle; 2. 3M™ DBI-SALA® ExoFit NEX™; 3. Podium Petzl and the like.

Method of manufacturing known work seats includes formation of a load-bearing framework by a rigid integral panel connectable to a safety harness.

Configuration of such known work seats may be classified as seats on a hinged-type movable surface. They have a simple and reliable design, but have some drawbacks, namely, their rigid integral load-bearing frameworks impede walking and their weight and dimensions cause some limitations for use in sports and expeditions.

A known speleology harness MTDE Picos includes a built-in flexible seat strap and has the following drawbacks: when in a suspended position, the mentioned strap compresses bones and pelvic organs and limits hip movements.

A solution that is most relevant to what is claimed and thus considered as a closest prior art is a safety harness comprising a seat with a rigid integral load-bearing framework (U.S. Pat. No. 5,131,490A Harness and seat board repelling system). However, this solution has all drawbacks typical for safety harnesses of this type.

Use of one-way bending chains is known for various industries, for example: 1. A pull chain for an escalator (Escalators. A. M. Oleynik, I. N. Pominov, Moscow, Mashinostroenie, 1973, p. 114. 2. Cable drag chains. 3. A load-carrying conveyer belt.

There are patents related to one-way bending chains: SU23038 Roller-based hinged chain with one-side pivoted links; SU1479379 One-way bending chain; SU304374 One-way bending chain; U.S. Pat. No. 6,510,682 Cable drag chain; CA2445267A1 Energy drag chain, a common feature of which is presence of stops on plates of adjacent links, wherein engagement of the stops limits the chain flexure (see FIG. 4).

Use of one-way bending chains for formation of load-bearing frameworks of seats provides new useful properties thereof and assures substantial improvements in operational and ergonomic characteristics of safety harnesses.

### SUMMARY OF THE INVENTION

An object of the claimed invention is improving operational and ergonomic characteristics of full body harnesses, i.e., their safety, mobility and usability.

The seat of the invention provides the following advantageous effects. It has compact size, when in folded state (for storing, packing or transporting). It is conveniently secured near pelvis and always ready to use, when in non-operational position; meanwhile, it does not hinder walking, climbing or descending; thus, mobility is improved and field of application is widened, including sport climbing, cave descending, high-rise works, rescue operations and tree hunting. When necessary, it may be readily transferred into operational position by rotation relative to its longitudinal axis. A U-shaped load-bearing framework assures physiology-friendly abutment on ischial tuberosity and provides comfortable conditions for long residence in a support-free environment. At the same time, a pressure exerted by flexible suspension branches onto pelvis and hips is avoided, so risk of orthostatic collapse occurrence is dramatically reduced. A load strap provides possibility of securing equipment, outfit and materials.

### BRIEF DESCRIPTION OF THE DRAWINGS

Essence of the invention is illustrated by the attached figures as follows.

FIG. 1 shows a seat on a user's body in operational position and non-operational position.

FIG. 2 shows how a seat is secured to a safety harness.

FIG. 3A shows a seat in operational position.

FIG. 3B shows a seat in non-operational position.

FIG. 4 shows an escalator pull chain.

FIG. 5A shows a seat cover.

FIG. 5B shows a seat with a cover in non-operational position.

FIG. 5C shows a seat with a cover in operational position.

FIG. 6A shows a U-shaped load-bearing framework consisting of lamellar single-strand links, in an orthogonal view.

FIG. 6B shows a U-shaped load-bearing framework consisting of lamellar single-strand links, in a side view.

FIG. 7A shows a load-bearing framework in a form of a flexible assembly, in bent position.

FIG. 7B shows a load-bearing framework in a form of a flexible assembly, in folded position.

FIG. 8A shows a lamellar single-strand link.

FIG. 8B shows a lamellar single-strand pivoted link.

FIG. 8C shows a lamellar single-strand terminal link.

FIG. 9A shows a lamellar single-strand link, a kinematic couple and formation of a load-bearing beam.

FIG. 9B shows a lamellar single-strand link, a kinematic couple and formation of a flexible assembly.

FIG. 9C shows a lamellar single-strand link, a kinematic couple and formation of a U-shaped load-bearing framework.

FIG. 10A shows a lamellar link, type A, ready-assembled.

FIG. 10B shows a bearing connection unit.

FIG. 10C shows a connection unit and a kinematic couple.

FIG. 10D shows a pivoted joint unit.

FIG. 10E shows a U-shaped load-bearing framework, type A, in an orthogonal view.

FIG. 11A shows a lamellar link, type B, ready-assembled.

FIG. 11B shows a reinforced bearing connection unit.

FIG. 11C shows a reinforced stopper unit.

FIG. 12 shows a light lamellar link, type C.

FIG. 13A shows a link formed as a three-dimensionally bent wire frame.

FIG. 13B shows a U-shaped load-bearing framework, with each link formed as a three-dimensionally bent wire frame.

FIG. 14A shows a lamellar double-strand link, with support surface formed by two tubular cushions made of a damping material.

FIG. 14B shows a link and a kinematic couple.

FIG. 14C shows a stop provided in a form of a shaped cut and a notched bend.

### DETAILED DESCRIPTION OF THE INVENTION

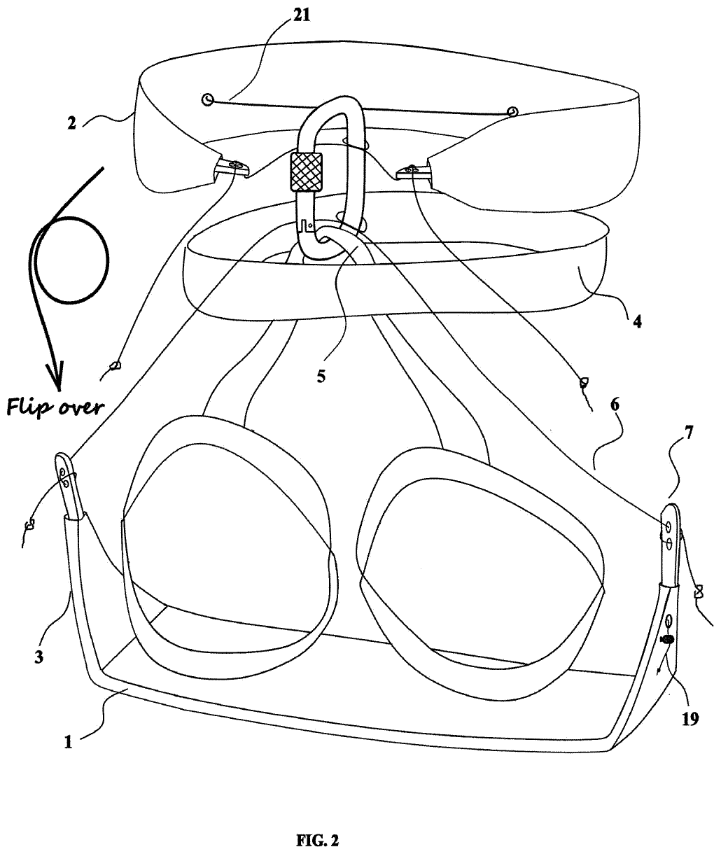

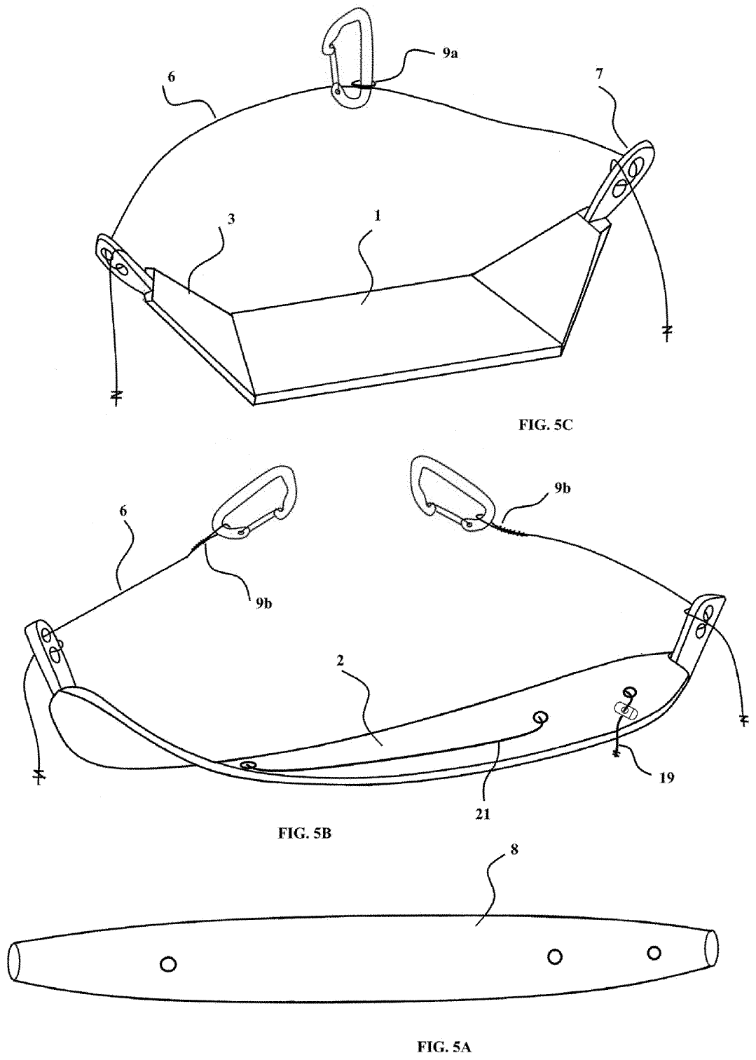

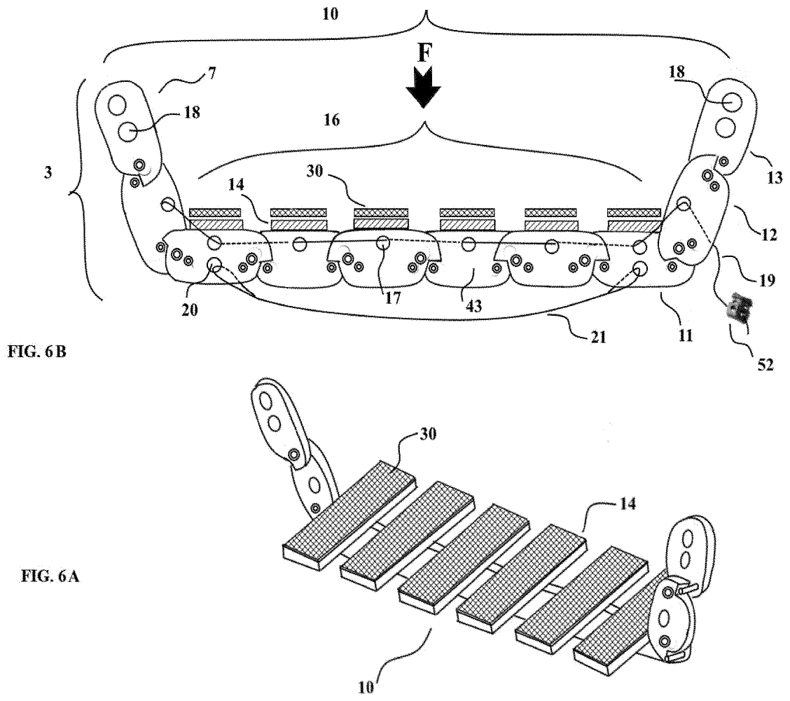

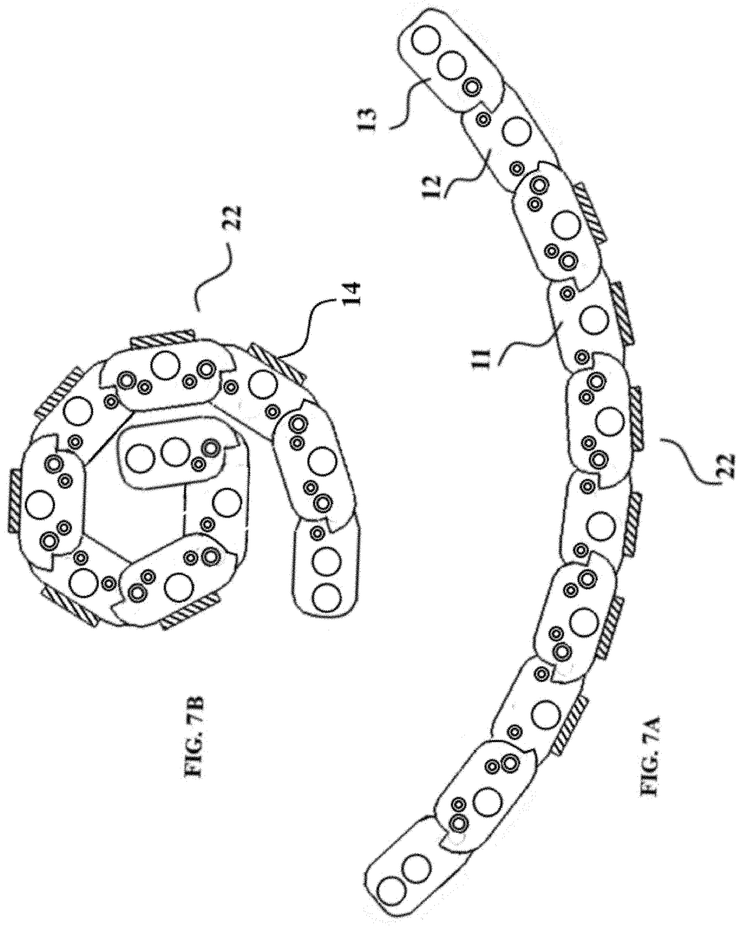

A method of manufacturing a seat 1 (FIG. 2) for a safety harness comprises formation of a load-bearing framework 10 (FIGS. 6A, 6B) by a one-way bending chain 22 that includes multiple sequentially connected links 11 (FIGS. 7A, 7B) forming a support surface 16 (FIG. 6B).

The seat 1 includes a load-bearing framework 10 formed by the one-way bending chain 22 that includes multiple links 11 connected in series. The links 11 form a support surface 16 of the seat 1.

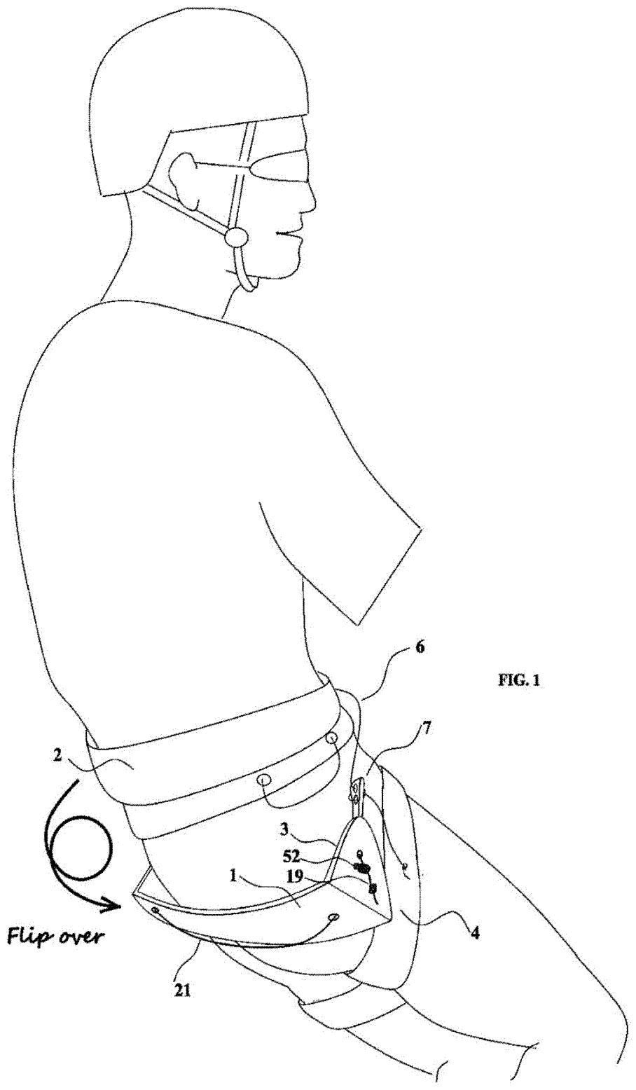

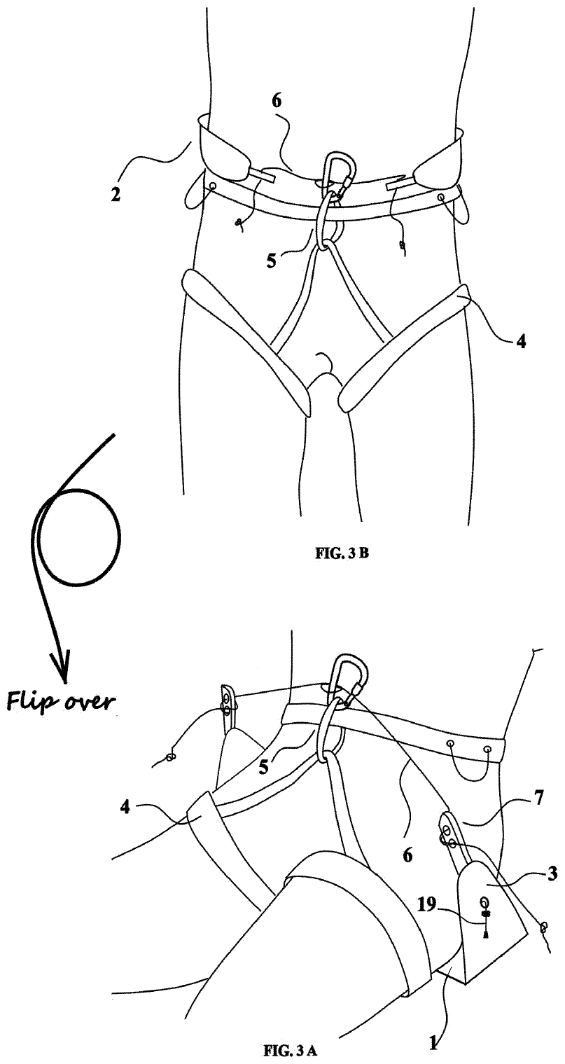

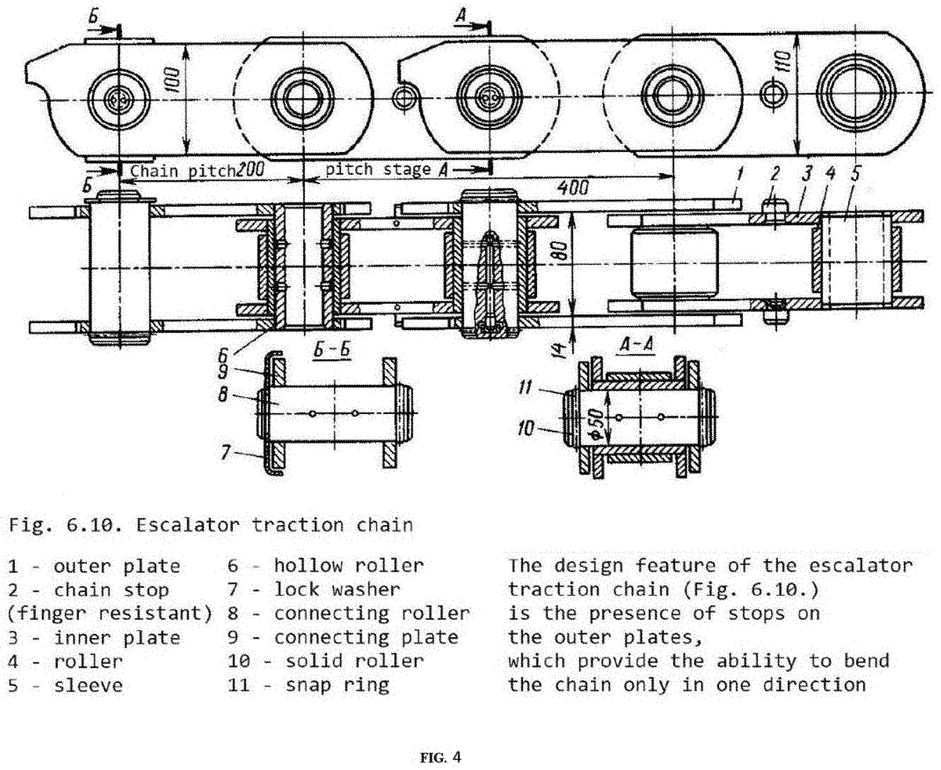

One-way bending chain means here a chain that can be easily bent in one predetermined direction and unbent again, but cannot be easily bent in other directions. Use of the one-way bending chain 22 for forming the load-bearing framework 10 of the seat 1 allows providing two functional states of the chain: in a form of a flexible assembly (FIGS. 7A, 7B) and in a form of the rigid load-bearing framework 10 (FIGS. 6A, 6B). When in a non-operational position 2 (FIGS. 1, 2, 3B), the flexible assembly is kept near the user's pelvis. To transit it into an operational position, in a form of the seat 1 (FIG. 3A), it shall be turned over (rotated by 180° over its longitudinal axis) and placed under the user's buttocks. During that, stops 24 and 25 of adjacent links are engaged so as to limit flexure in direction of the load vector projection and to form the load-bearing framework 10 that receives the forces applied to the seat 1.

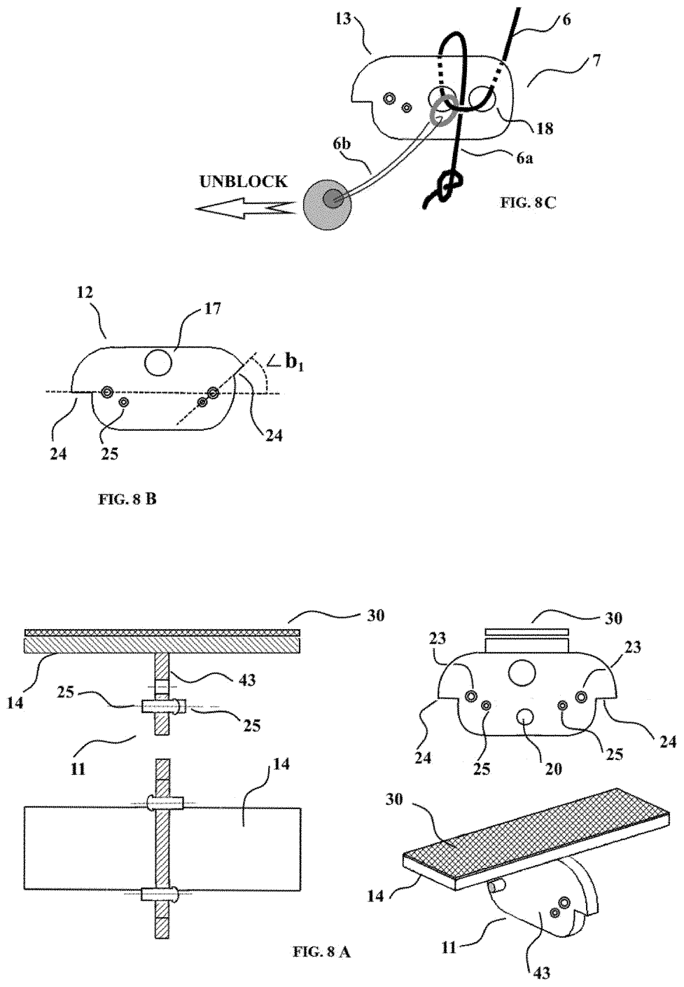

The lamellar single-strand link 11 is intended for formation of the framework 10 and the support surface 16 of the seat 1 and includes a bearing plate 43 having axial openings 23 to provide hinged connection of adjacent links, stops formed as a shaped cuts 24 and press-fitted pins 25, wherein engagement of the stops limits the chain flexure, fastening holes 17 (for a position retainer or stretcher 19), 18 (for a flexible suspension 6), 20 (for a load strap 21), and a support plate 14 attached thereto (FIGS. 8A, 8B, 8C).

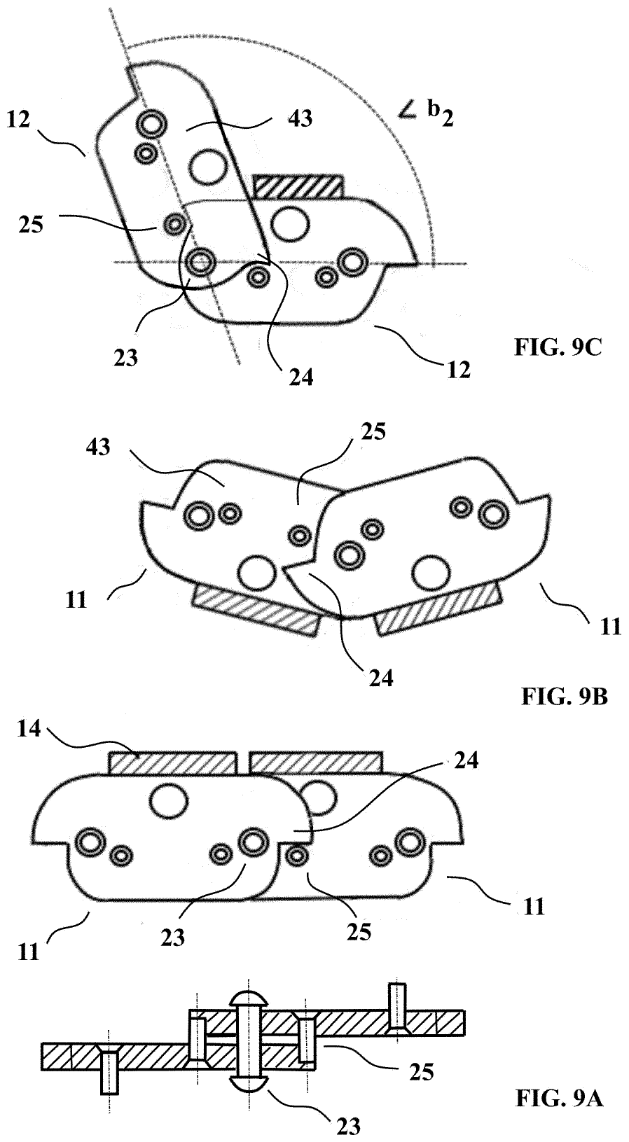

The pivoted link 12 is intended for formation of ears 3 of the U-shaped framework 10 and its configuration is similar to the link 11, except for an angle position of a stopping bevel of the shaped cut 24, which is displaced by angle ‘b₁’ relative to longitudinal axis of the link, wherein the angle ‘b₁’ is proportional to predetermined link pivot angle ‘b₂’ (see FIGS. 8B, 9C).

The links 11 are assembled sequentially, either in separable or non-separable manner, and the load-bearing framework is formed when the shaped cut 24 stopping bevel abuts on the pin 25 press-fitted into plate of the link 11, so the whole branch of the chain is held rigidly in a near-linear position and no any substantial bend occurs in the inward direction of its contour (see FIGS. 6B, 9A). When the chain is bent in the opposite direction, the stops 24 and 25 disengage and do not impede the bending, so the chain may be folded in a compact manner (see FIGS. 7A, 7B).

The stretcher 19 provides automatic transition of the load-bearing framework 10 and fixing thereof in the working position 1, when the framework is turned over from a non-working position 2 corresponding to the flexible assembly due to resilient deformation of an element, e.g., a rubber cord, freely extending through the holes 17 of the links 11. The stretcher 19 may be configured to adjust a tension force, e.g., by a clamp 52. The holes 17 for passing the stretcher 19 are shifted out of the link axis in the direction of the bearing plate 14.

The flexible suspension 6 is intended to connect binding elements 5 of the safety harness 4 and represents a piece of a rope secured by an adjustment unit 7 of an end link 13. The flexible suspension 6 may be provided with various fasten options, e.g., with one rope piece and a central loop 9a, or with two rope pieces and loops 9b, or with adjustment buckles. The flexible suspension 6 may be made in various forms like a tape, a rope, a cord or a cable (see FIGS. 3A, 3B, 5B, 5C, 6B).

The adjustment unit 7 provides connecting, adjusting and fixing length of the flexible suspension 6 and includes shaped holes 18 provided in the end links 13 of the load-bearing framework 10 of the seat 1, e.g., similar to device Kong Slyde.

The flexible suspension is fixed by a loop formed by the loaded end of the flexible suspension 6 and passing through the holes 18 so as to clamp the free end of the rope 6a, when a load applies. When load is off, the flexible suspension is unfixed using a metal ring and a textile loop 6b equipped with a small ball for convenience of handling. Free ends of the flexible suspension are knotted (FIG. 8C).

The load strap 21 serves for securing various outfit and represents a piece of a rope having two loops secured in holes 20 of the links or in a hollow axial sleeve 23. The load strap may be made of a tape, a rope, a reepschnur, or a cord (FIG. 6B).

The ears 3 are intended for shifting a connection point of the flexible suspension 6 and end links 13 of the framework 10 outside user's hip area to avoid pressure exerted thereon by branches of the flexible suspension 6 (FIGS. 2, 3A).

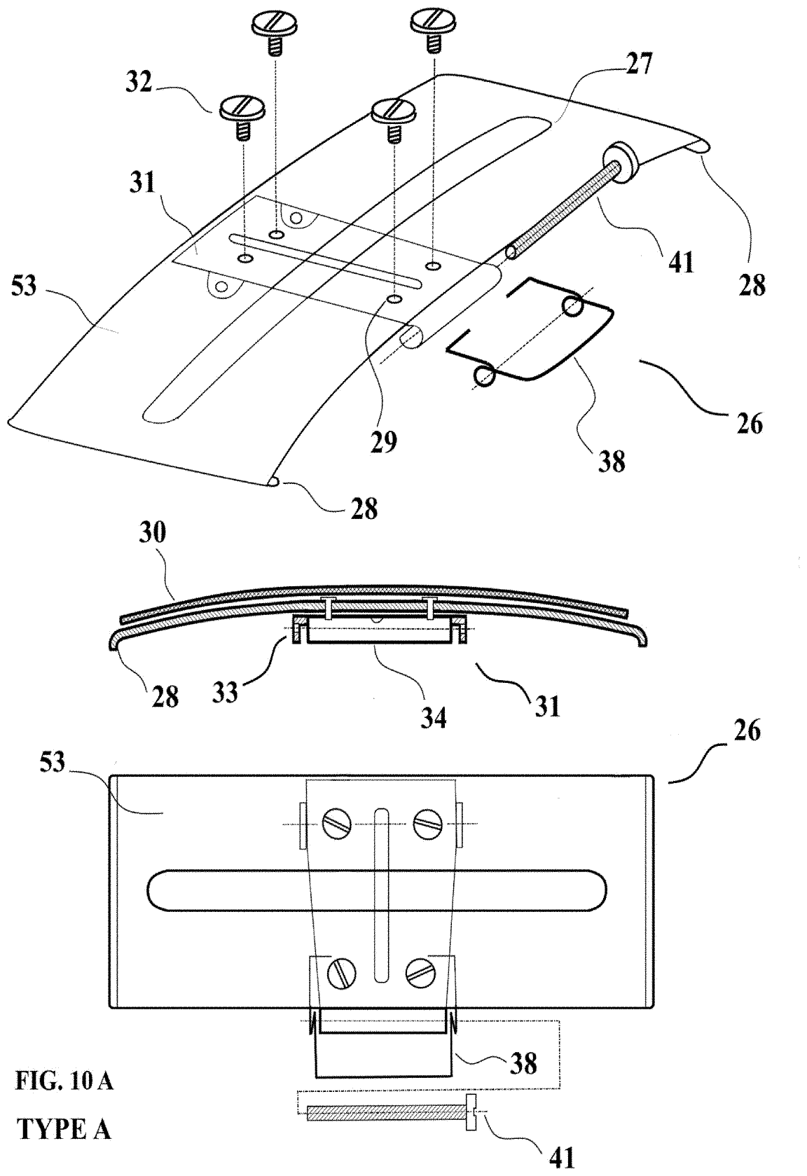

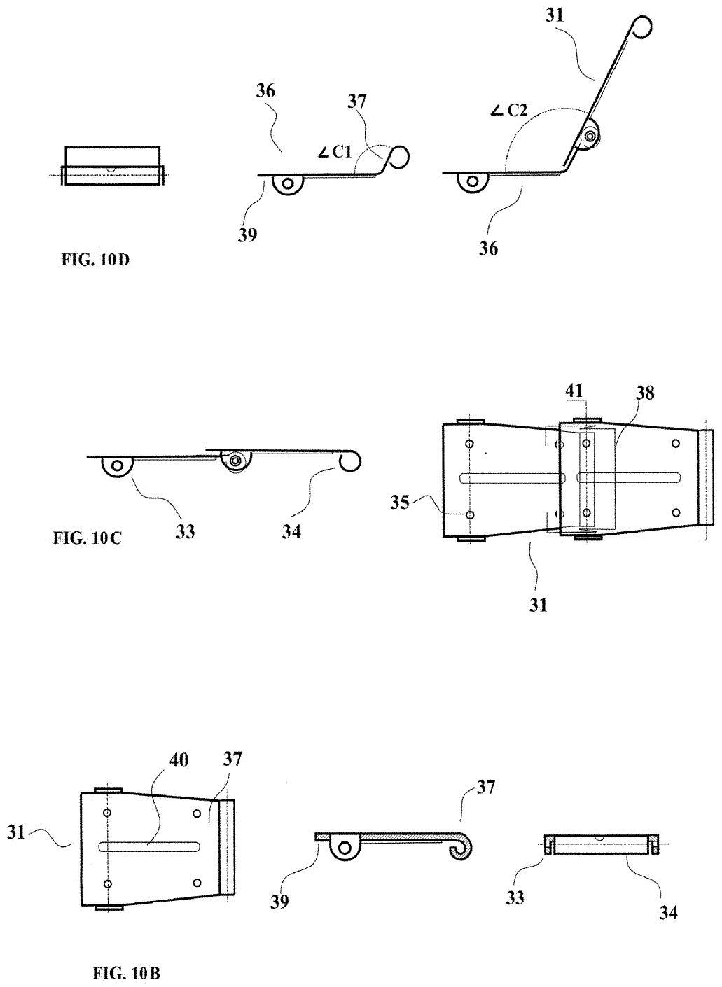

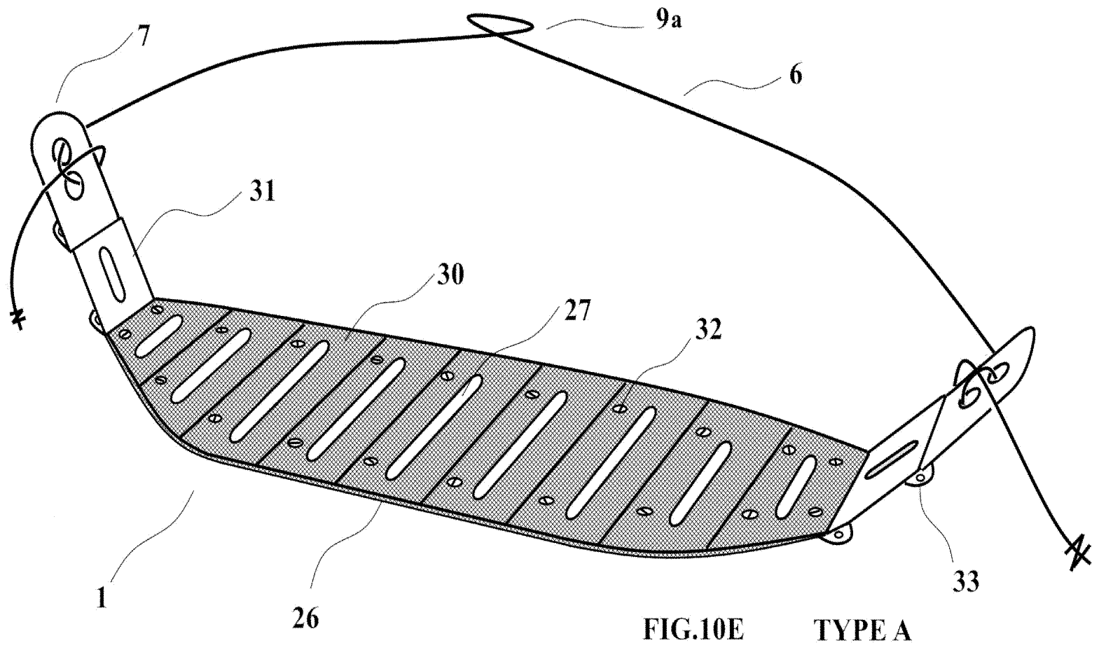

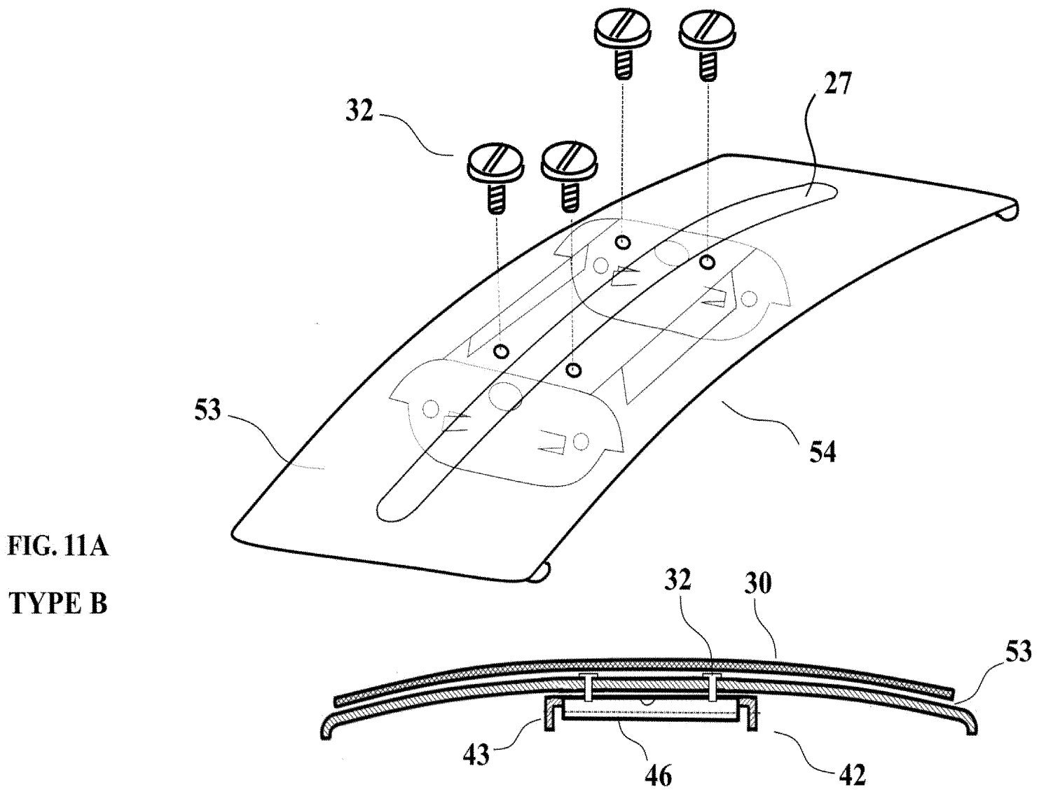

In addition, a preferable embodiment of the invention employs a lamellar link 26, type A, that is intended to form the load-bearing framework and the support surface 16 of the seat 1. The lamellar link 26 includes a connection unit 31 and a support plate 53 connected to the link by screws 32. The support plate 53 includes an embossed stiffening rib 27 located normally to a longitudinal axis of the link, flanged edges 28 to provide twist and bend rigidness, fastening holes 29, and a damping pad 30 (FIG. 10A).

The load-bearing connection unit 31 is intended to attach the support plate 53, to interconnect the lamellar links 26 and to form a one-way bending chain. The connection unit 31 is made of a strengthened quality flat metal in order to assure structural strength at a minimal weight. The connection unit 31 includes bent ears 33, a sleeve 34, threaded fastening holes 35 and an embossed stiffening rib 40 (FIG. 10B).

A pivoted connection unit 36 is intended to form ears 3 of the U-shaped load-bearing framework and is similar to the connection unit 31, except for an angle position of a support wing of a shoulder 37, which is displaced by angle ‘c₁’ relative to longitudinal axis of the unit, wherein the angle ‘c₁’ is proportional to predetermined link pivot angle ‘c₂’ (see FIG. 10D).

The connection units 31 are assembled sequentially, while the ears 33 and the sleeve 34 of adjacent links and a double twisted spin spring 38 are mounted on an axle 41 (FIG. 10C) to provide automatic transition of the flexible assembly (in the non-working position 2) into the load-bearing framework 10 (in the working position 1).

A kinematic couple of connection units 31 provides one-way bending, while the load-bearing framework is formed, when an inner wing of a shoulder 39 abuts on an outer wing of the shoulder 37, so the whole chain branch is firmly held in a near-linear position and no any substantial bend occurs in the inward direction of its contour (see FIG. 10C). When the chain is bent it the opposite direction, the support wings of the shoulders 37 and 39 of adjacent links are disengaged and do not impede the bending, so as to allow folding the chain in a compact manner.

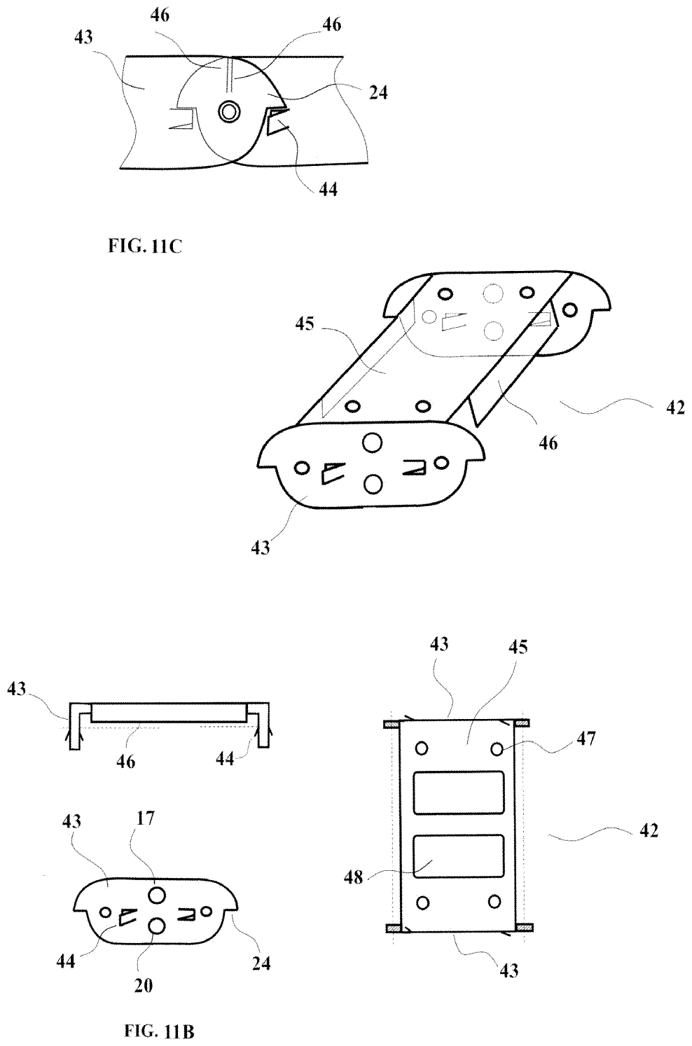

In addition, a preferable embodiment of the invention employs a reinforced lamellar link 54, type B, that is intended to form the load-bearing framework and the support surface 16 of the seat 1 suitable for high load operations. The lamellar link 54 includes a connection unit 42 and a support plate 53 connected to the link by screws 32 (see FIG. 11A).

The reinforced connection unit 42 is intended to attach the support plate 53, to connect the lamellar links 54 and to form a one-way bending chain. It is intended for high load operations and is bent of a strengthened quality flat metal in order to assure structural strength at a minimal weight, together with bent bearing plates 43 and fastening plates 45, stops 24 and 44¹, flanged stop 46, threaded fastening holes 47 and perforation 48 (see FIGS. 11B, 11C).

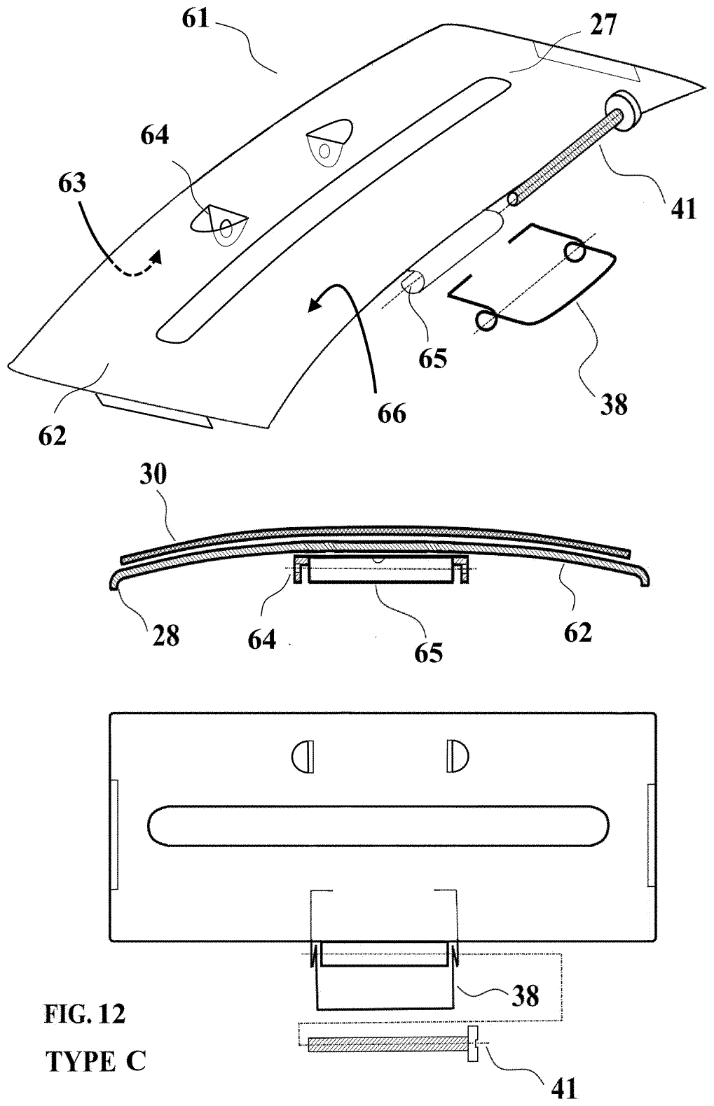

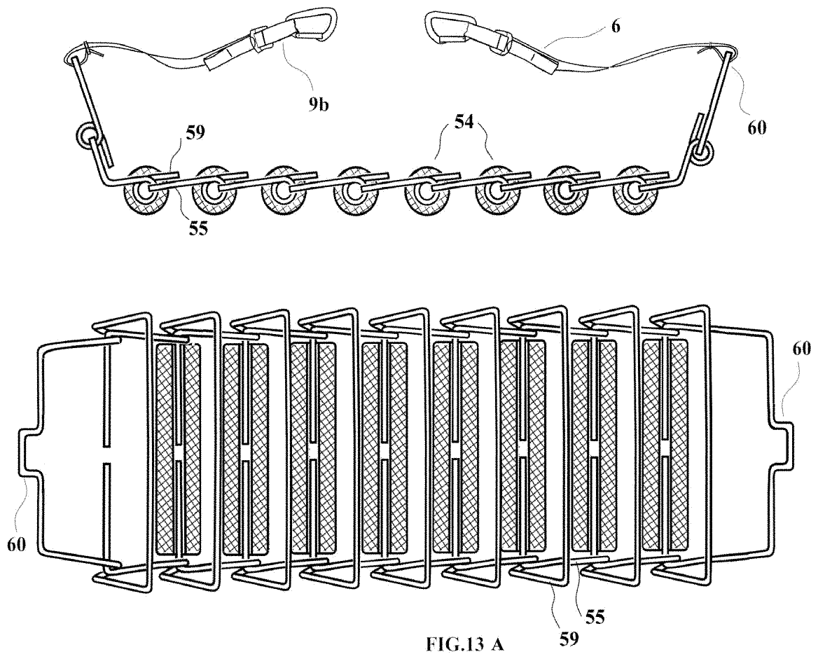

The stops of the connection unit 42 provide improved strength of the engaged surfaces while forming the load-bearing framework of the seat 1 and represent a double combination of the shaped cut 24 at the link end and a notched bend 44 with additional butt flanged stop 46 (see FIG. 11C). The load-bearing framework is formed when the shaped cut 24 bevel abuts on the notched bend 44 of the plate 43 and the flanged stops 46 are engaged, so the whole chain branch is firmly held in a near-linear position and no any substantial bend occurs in the inward direction of its contour (see FIG. 12C). When the chain is bent it the opposite direction, the stops 24, 44 and 46 are disengaged and do not impede the bending, so as to allow folding the chain in a compact manner.

In addition, a preferable embodiment of the invention employs a light lamellar link 61, type C, that is intended to form the load-bearing framework and the support surface 16 of the seat 1. The light lamellar link 61 represents a plate 62 that is bent of a strengthened quality flat metal to assure structural strength at a minimal weight, together with bent ears 64 and a sleeve 65, which hinge each couple of the links 61, with the embossed stiffening rib 27 located normally to longitudinally axis of the link, and with flanged edges 28 to provide twist and bend rigidness (see FIG. 12). The links 61 are assembled sequentially, while the ears 64, the sleeve 65 of adjacent links and a double twisted spin spring 38 are mounted on an axle 41 to provide automatic transition of the load-bearing framework and fixing thereof in working position 1, when the flexible assembly is turned over from the position 2. The load-bearing framework is formed, when an inner wing of a shoulder 63 abuts on the outer wing of the shoulder 66, so the whole chain branch is firmly held in a near-linear position and no any substantial bend occurs in the inward direction of its contour. When the chain is bent it the opposite direction, the support wings of the shoulders 63 and 66 of adjacent links are disengaged and do not impede the bending, so as to allow folding the chain in a compact manner.

The support plates 14, 53 and 62 may be made of steel, aluminum, titanium alloys or composite materials and may be perforated. In order to provide thermal isolation and comfort, the plate surface may be covered with damping materials 30 attached by a chemical or a mechanical method or with a seat cover 8 (see FIGS. 5A, 6A, 10A). The cover may be attached to the bearing plate 43 and 31 in a form of a continuous surface or it may have some gaps.

Center of the support surface 16 of the support framework 10 represents center of combination of loads from transversal forces and bending moments and receives highest load F (see FIG. 6B), which may cause deformation of links and units of the chain under various operational conditions, e.g., in case of sudden stop while rappelling. In order to ensure its load capacity under the indicated conditions, the framework may have a variable profile, where central link (or multiple links) may have increased cross-section dimensions.

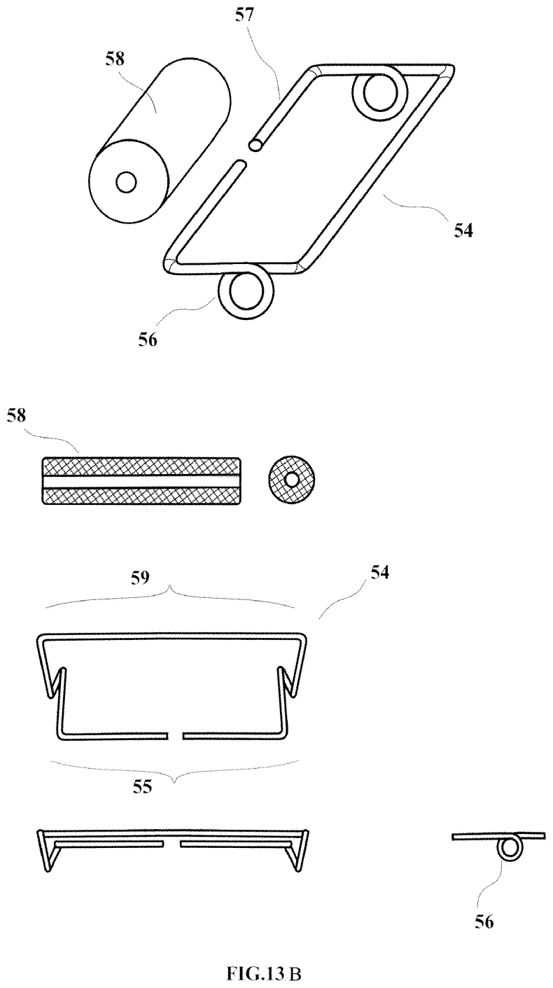

In addition, a preferable embodiment of the invention employs a link 54 that is intended to form the lad-bearing framework and the support surface 16 of the seat 1. The link 54 represents a reinforced three-dimensionally bent frame made of a metal rod formed as a double twisted spin spring together with ears 56 and axles 57, which hinge each couple of the links 54, and with a support surface of the seat formed as two tubular supports 58 made of a damping material and attached to the axles 57. The load-bearing framework is formed when a shoulder 59 abuts on the shoulder 55 with the axles, so the whole chain branch is firmly held in a near-linear position and no any substantial bend occurs in the inward direction of its contour as the axles 57 receive the main tension force. When the chain is bent it the opposite direction, the shoulders 59 and 55 of adjacent links are disengaged and do not impede the bending, so as to allow folding the chain in a compact manner. The flexible suspension 6 is made of a tape with loops 9b and adjustment buckles and is secured to the wings 60 (see FIGS. 13A, 13B).

The load strap and the stretcher of the lamellar link 54 are similar to the load strap 21 and the stretcher 19 of the link 11.

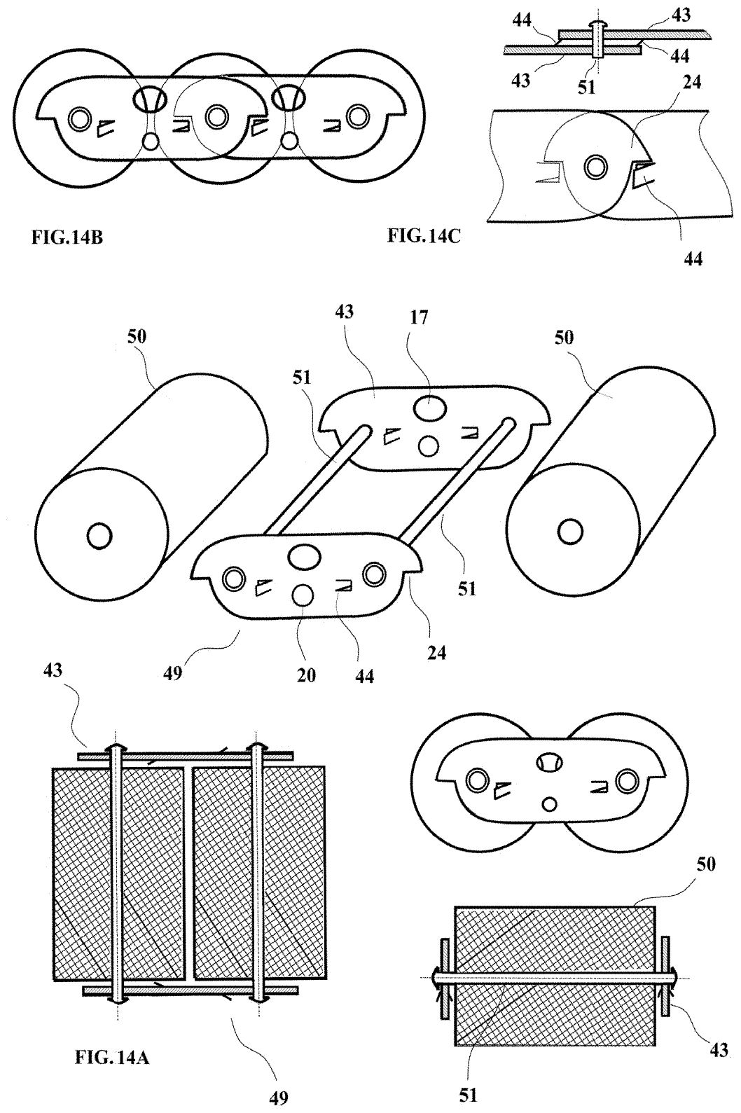

In addition, a preferable embodiment of the invention employs a lamellar double-strand link 49 that is intended to form the framework and the support surface 16 of the seat 1. The link 49 is structurally similar to the connection unit 42 (see FIG. 11B) and has a support surface of the seat formed as two tubular supports 50 made of a damping material and attached to axial bars 51, which connect plates 43. The link 49 has an improved load capability owing to use of a double combination of stops 24, 44 and a comfortable seat surface owing to increased thickness of the tubular supports 50. It also has an increased height of the chain profile and extended seat size owing to increased diameter of the tubular supports 50, which, however, may be a substantial drawback in view of passing narrow areas and meanders in caves (see FIGS. 14A, 14B, 14C).

Links of a one-way bending chain may be configured differently, e.g., similar to links of a fork-shaped chain or a Redler chain or a cable drag chain, and may comprise more than two rows of the bearing plates 43, and also may be connected either in separable or non-separable manner.

Sizes of the foldable seats may be different, depending on user's body dimensions and application area, and may be adjusted by adding or removing additional links.

The framework of the seat may be structurally integrated with the safety harness during production.

### PRESENTLY PREFERRED EMBODIMENT

The seat is developed to provide comfortable continuous sitting in a support-free environment when used with safety harnesses in mountaineering, rock climbing, cave descending, high-rise works, rescue operations and as a tree hunting saddle.

The seat may be used as follows: 1. A user attaches the loop 9a or 9b of the flexible suspension 6 of the seat 1 to binding elements 5 of the safety harness 4 (FIGS. 3A, 3B). 2. The user adjusts a length of the flexible suspension 6, depending on the user's position. 3. When in non-operational position B (FIG. 3B), the seat is secured near pelvis, so it does not hinder walking, climbing or descending and is always ready to use. 4. To transfer into operational position A (FIG. 3A), the seat 1 shall be moved under the buttocks and rotated by 180° over its longitudinal axis so as to form the load-bearing framework 10 receiving forces applied to the seat 1.5. The U-shaped load-bearing framework assures physiology-friendly abutment on ischial tuberosity and provides comfortable conditions for long residence in a support-free environment. At the same time, a pressure exerted by flexible suspension branches onto pelvis and hips is avoided, so risk of orthostatic collapse occurrence is reduced to a minimal value. 6. The load strap 21 provides possibility of securing equipment, outfit and materials.

### ATTENTION

This seat shall not be used separately from a safety harness.
Load straps shall be used for securing outfit only.
This product is allowed for using by skilled persons received a special training.

Thus, the claimed invention allows avoiding drawbacks of seats having rigid integral support framework and provides new opportunities for substantial improvement of operational and ergonomic characteristics of seats used with safety harnesses.

The above description, examples and data provide a comprehensive disclosure of implementation and use options for the invention embodiments.

This application describes method and design for implementation a seat and covers any variations or adaptations of the invention according to features of the independent claims.

Preferable embodiments of the invention are covered by dependent claims and clarified in the detailed description, partially with reference to the figures.

1. A seat for safety harness comprising a load-bearing framework formed by a one-way bending chain that includes multiple sequentially connected links forming a support surface of the seat.

2-3-4 (canceled)

5. A method of manufacturing a seat for safety harness, the method comprising formation of a load-bearing framework by a one-way bending chain that includes multiple sequentially connected links forming a support surface of the seat.

6. A method of use of a seat for safety harness, the method comprising turning over a load-bearing framework formed by a one-way bending chain that includes multiple sequentially connected links forming a support surface of the seat, so as to transit the load-bearing framework into its operational position.
